(19) United States
(12) Patent Application Publication
(10) Pub. No.: US 2006/0158030 A1
(43) Pub. Date: Jul. 20, 2006

(54) Pressure controller

(75) Inventors: Erhard Beck, Weilburg (DE); Karlheinz Haupt, Gau-Algesheim (DE); Rudiger Briesewitz, Bruchkobel (DE)

Correspondence Address: Craig Hallacher;Continental Teves Inc, One Continental Drive, Auburn Hills, MI, 48326, US

(73) Assignee: Continental Teves AG & Co. oHG

(21) Appl. No.: 10/546,356

(22) PCT Filed: Dec. 19, 2003
(86) PCT No.: PCT/EP03/14635

§ 371 Date: Aug. 19, 2005

(30) Foreign Application Priority Data
Feb. 20, 2003 (DE) 103 07 236.5
Sep. 19, 2003 (DE) 103 43 310.4

(51) Int. Cl. B60T 8/36

(52) U.S. Cl. 303/119.3

(57) ABSTRACT

The present device relates to a pressure controller, in particular for a slip-controlled brake system in a motor vehicle, which is equipped with a first housing (1) for the accommodation of several pressure control valves and with a second housing (2) arranged on the first housing (1) and accommodating electric and/or electronic components which electrically contact several pressure sensors arranged in a sensor housing (3) when the second housing (2) is placed on the first housing (1), and at least one device is arranged between the sensor housing (3) and the second housing (2) for the compensation of process and assembly tolerances.

### BACKGROUND OF THE INVENTION

The present invention relates to a pressure controller, in particular for slip-controlled motor vehicle brake systems.

DE 198 41 334 A1 discloses a pressure controller of this type for a wheel-slip controlled motor vehicle brake system which includes a first housing for accommodating a plurality of electrically operable pressure control valves and a second housing for accommodating electric and electronic components. When the second housing is placed on the first housing, not only the pressure control valves but also a plurality of pressure sensors arranged in a block-shaped sensor housing are electrically contacted. The sensor housing is fluid-tightly closed by a cover provided with a seal-tight electric plug to permit an electric connection between the pressure sensors and the electric and electronic components in the second housing. The sensor housing along with the cover forms an independently operable, structurally complicated pressure sensor module which must be attached in an extremely precise fashion between the two housings by means of clamping bolts.

### SUMMARY OF THE INVENTION

In view of the above, an object of the invention is to simplify the structure of the pressure controller.

According to the invention, this object is achieved for a pressure controller of the type mentioned hereinabove using a second housing arranged on a first housing and a compensation device arranged between a sensor housing and the second housing to compensate for process and assembly tolerances.

Further features, advantages and possible applications of the invention can be taken from the description of several embodiments by way of the accompanying drawings.

### BRIEF DESCRIPTION OF THE DRAWINGS

In the drawings:

FIG. 1 shows a first embodiment of the invention in a partial view of a pressure controller in the area of a pressure sensor module that is provided with a separately operable housing frame;

FIG. 2 shows a second embodiment of the invention in a partial view of a pressure controller in the area of a pressure sensor module, the housing frame of which is integrally connected to a first housing;

FIG. 3 shows a third embodiment of the invention in a partial view of a pressure controller in the area of a pressure sensor module, the housing frame of which is integrally connected to the pressure sensor module;

FIG. 4 is an exploded view of the pressure sensor module.

### DETAILED DESCRIPTION OF THE DRAWINGS

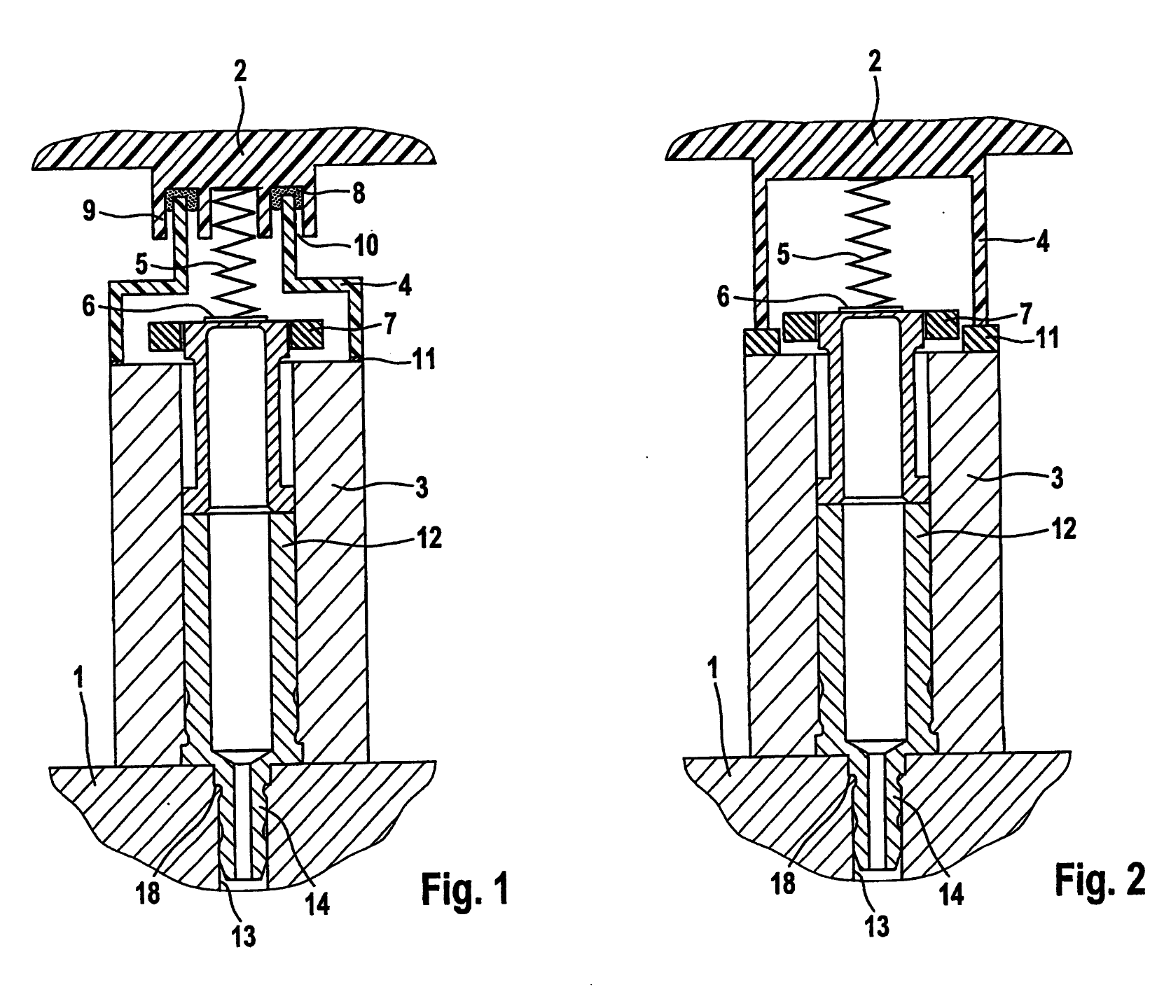

FIGS. 1-3 respectively show in a schematic view a pressure sensor module of a pressure controller in a cross-sectional side view being e.g. used for a slip-controlled brake system in a motor vehicle. The pressure controller is equipped with a block-shaped first housing 1 for the accommodation of a plurality of electrically operable pressure control valves and a cover-shaped or plate-shaped second housing 2 for the accommodation of electric and/or electronic components 5 of an electronic control unit. The second housing 2 is placed on the pressure sensor module attached to the first housing 1. The pressure sensor module is basically composed of a block-shaped sensor housing 3 which is flanged at the first housing 1 by means of several pressure pipes 12.

In all embodiments illustrated in FIGS. 1-3, the sensor housing 3 is designed as a rectangular block-shaped housing, at the plane end surface of which that is remote from the first housing 1 there is arranged a seal 11, pressure measuring elements 6 and a circuit board 7 that is electrically connected to the pressure measuring elements 6. Further, several pressure pipes 12 are attached in the sensor housing 3 side by side in a row, said pressure pipes projecting in the area of a flange surface of the sensor housing 3 that abuts on the first housing 1. The pressure pipes 2 extend with their pipe portions 14 projecting from the sensor housing 3 into several pressure channels 13 of the first housing 1 and are tightly connected to the first housing 1 by means of a so-called self-calking engagement. The pressure channels 13 are in connection with the electrically operable pressure control valves which, preferably, control the brake pressure in several wheel brakes of a motor vehicle.

For the simple, yet reliable attachment and sealing of the pressure pipes 13 in the first housing 1 by means of self-calking engagement, the material of the pipe portions 14 exhibits a greater hardness than the material of the first housing 1. To displace the softer material of the first housing 1 into the recesses 16 of the pipe portions 14, the pipe portions 14 have stepped portions 18 which, in the capacity of a calking punch, provide an undetachable, leakproof connection between the pressure pipes 12 and the first housing 1 when the pipe portions 14 are forced into the pressure channels 13.

Likewise the pressure pipes 12 are connected to the sensor housing 3 by means of a self-calking engagement in an undetachable and fluid-tight fashion already before they are forced into the first housing 1, for what reason the material of the sensor housing 3 has a hardness lower than that of the material of the pressure pipes 12, which are likewise provided at their periphery with stepped portions for displacing the softer material of the sensor housing 3 into the recesses 16 at the pressure pipes 12. The pressure pipes 12 are preferably made of steel, while the first housing 1 and the sensor housing 3 are manufactured using a light-metal alloy.

As the pressure sensor module corresponding to the previous illustration is undetachably connected to the first housing 1, special measures need to be taken to ensure a simplest possible, fluid-tight and safe electrical connection between the pressure sensor module and the electric and electronic components in the second housing 2 irrespective of process and assembly tolerances.

In view of the above, the invention proposes that at least one means for compensating process and assembly tolerances is arranged between the sensor housing 3 and the second housing 2, for what purpose an elastic and sealed electric contact 5 is especially appropriate that is preferably designed as a spring contact which, when required, between the sensor housing 3 and the second housing 2, is able to bridge a radial or lateral offset between the contact surfaces of the second housing 2 and the pressure sensor module for the purpose of tolerance compensation.

For the sake of clarity, the illustration of an offset has been omitted in FIGS. 1-3 so that in the ideal condition the second housing 2 with its electrical point of contact in the projection 9 is aligned coaxially relative to the pressure sensor module.

To seal the elastic electric contact 5, a housing frame 4 is provided between the sensor housing 3 and the second housing 2. The electric contact 5 which is preferably configured as a helical spring abuts with the end of a spring winding within the housing frame 4 on a generously sized contact surface 16 of a circuit board 7 in a mechanically biased manner. The circuit board 7 accommodates the electric and/or electronic components 6 necessary for several pressure measuring elements 6, received among others by a pressure signal evaluating circuit. The result is a unit whose function can be pre-tested before the pressure sensor module is undetachably fastened at the first housing 1.

The housing frame 4 plunges with its end area remote from the sensor housing 3 into an elastic or plastic sealing material 8, which compensates the process and/or assembly tolerances and is injection-molded into a housing groove 10 within the projection 9 arranged at the bottom side of the second housing 2. A silicone gel is especially appropriate as sealing material 8.

In order to compensate the assembly and process tolerances, the width of the housing groove 10 is dimensioned larger than the wall thickness of the housing frame 4 by a tolerance rate required therefor, with the result of safeguarding a reliable, moisture-proof sealing of the sensitive electric and/or electronic components in the pressure sensor module.

Following the above general description of the invention, some expedient details of the housing frame will now be explained more closely making reference to the FIGS. 1-3.

In the embodiment according to FIG. 1, the housing frame 4 is designed as an independently operable component, the end area of which remote from the second housing 2 bears against a circumferential seal 11 at the outside edge of the sensor housing 3. The housing frame 4 is preferably made of an injection-molded plastic material.

Different herefrom, FIG. 2 shows a housing frame 4 which is molecularly interfaced with the second housing 2, and the housing frame 4, for the compensation of process and assembly tolerances, radially displaceably abuts on a seal 11 at the sensor housing 3 that is preferably configured as a flat packing. The housing frame 4 along with the second housing 2 is made of plastic material, preferably in an injection-molding operation.

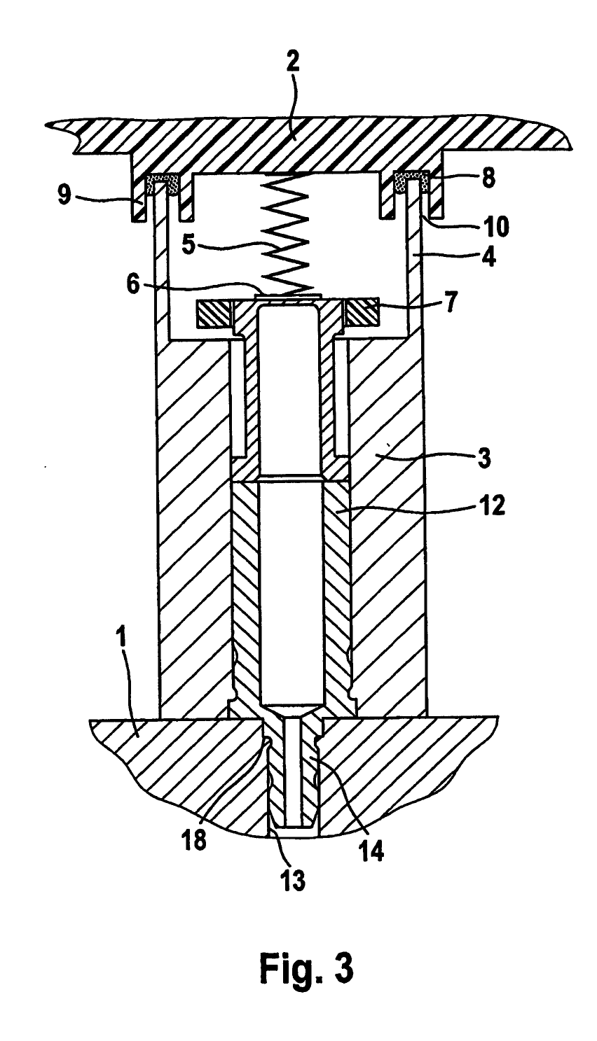

In the embodiment according to FIG. 3, the housing frame 4 is integrally connected to the sensor housing 3, and the end portion of the housing frame 4 directed to the second housing 2 plunges into an elastic or plastic sealing material 8 that is embedded into a groove-shaped projection 9 of the second housing 2. The housing frame 4 and the sensor housing 3 are composed of a solid extrusion, and the housing frame 4 is manufactured on the top side of the extrusion by means of a milling operation.

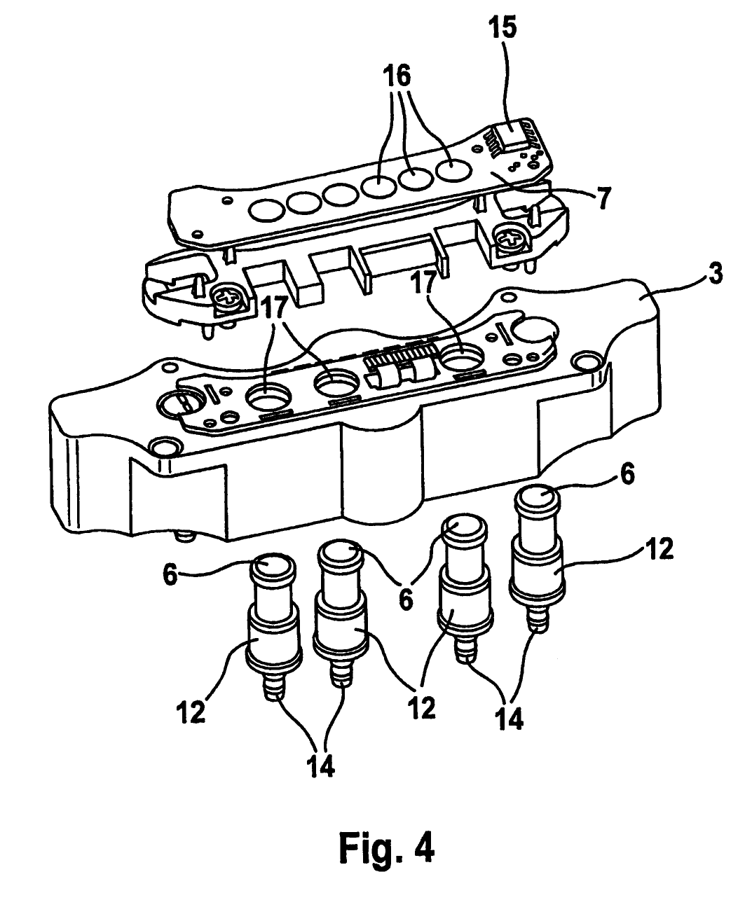

Based on the embodiment according to FIG. 2, FIG. 4 eventually shows an exploded view for the pressure sensor module, the slim sensor housing 3 of which is provided with four serially arranged bores 17 into which the four pressure pipes 12 shown from below are pressed. The pressure pipes 12 include on their top side the pressure measuring elements 6 which, after the pressure pipes 12 have been forced into the bores 17, are connected to the circuit board 7 preferably by means of flexible contact wires. Circuit board 7 is disposed above a solid carrier plate being rigidly interconnected after placement onto the top side of the sensor housing 6. On the top side of the circuit board 7, an electronic component 15 is arranged which comprises an evaluating circuit for the pressure signals of the pressure measuring elements 6. Further, several circular contact surfaces 16 arranged in a row can be easily seen on the surface of the circuit board 7, and the electric contacts 5 which are preferably fastened to the bottom side of the second housing 2 move into abutment on the contact surfaces.

### List of Reference Numerals

1 housing
2 housing
3 sensor housing
4 housing frame
5 electric contact
6 pressure measuring element
7 circuit board
8 sealing material
9 projection
10 housing groove
11 seal
12 pressure pipe
13 pressure channel
14 pipe portion
15 component
16 contact surface
17 bore
18 stepped portion

1-12. (canceled)

13. A pressure controller for a slip-controlled brake system in a motor vehicle, the pressure controller comprising:
a first housing for accommodating one or more pressure control valves;
a second housing arranged on the first housing for accommodating at least one electric component or one electronic component which electrically contact one or more pressure sensors arranged in a sensor housing when the second housing is placed on the first housing; and
a compensation device arranged between the sensor housing and the second housing in order to compensate for process and assembly tolerances.

14. The device according to claim 13, wherein the compensation device is an elastic electrical contact which is arranged between the sensor housing and the second housing in a radially displaced manner.

15. The device according to claim 14 further comprising:
a housing frame (4) arranged between the sensor housing (3) and the second housing (2) for sealing the elastic electrical contact (5) that is mechanically preloaded and abuts on a contact surface of a circuit board (7) within the housing frame (4), a circuit board accommodating the electronic components of a pressure signal evaluating circuit necessary for at least one pressure measuring element (6).

16. The device according to claim 15, wherein the housing frame (4) has an end area remote from the sensor housing (3) that is immersed into a sealing material (8) which compensates process and assembly tolerances and is inserted within a projection (9) arranged at the second housing (2), in particular into a housing groove (10) of the second housing (2), a width of the groove being dimensioned larger than a wall thickness of the housing frame (4) by a tolerance rate required for compensating assembly and process tolerances.

17. The device according to claim 16, wherein the housing frame (4) is designed as an independently operable component, the end area of which remote from the second housing (2) bears against a circumferential seal (11) at the outside edge of the sensor housing (3).

18. The device according to claim 15, wherein the housing frame (4) is molecularly interfaced with the second housing (2), and the housing frame (4) radially displaceably abuts on a seal (11) at the sensor housing (3) that is preferably configured as a flat packing.

19. The device according to claim 18, wherein the sensor housing (3) is designed as a rectangular block-shaped housing, at the plane end surface of which that is remote from the first housing (1) there is arranged the seal (11), at least one pressure measuring element (6) and the circuit board (7) that is electrically connected to the pressure measuring element (6).

20. The device according to claim 19, wherein one or more pressure pipes (12) are attached in the sensor housing (3) side by side in a row, said pressure pipes projecting in an area of a flange surface of the sensor housing (3) that abuts on the first housing (1), and the pressure pipes (12) having pipe portions (14) projecting from the sensor housing (3) and are fluid-tightly connected to the first housing (1) within several pressure channels (13) of the first housing (1).

21. The device according to claim 20, wherein the pipe portions (14) are comprised of a material that exhibits a greater hardness than a material of the first housing (1), and the pipe portions (14) have several stepped portions (18) for displacing the softer material of the first housing (1) into several recesses (16) of the pipe portions (14) which provide an undetachable, fluid-tight connection between the sensor housing (3) and the first housing (1).

22. The device according to claim 21, wherein the sensor housing is comprised of a material having a hardness lower than that of a material of the pressure pipes (12), which are provided with several stepped portions (18) for displacing the softer material of the sensor housing (3) into several recesses (16) at the pressure pipes (12) which are undetachably and fluid-tightly connected to the sensor housing (3).

23. The device according to claim 20, wherein the pressure pipes (12) are made of steel, and the first housing (1) and the sensor housing (3) are manufactured using a light-metal alloy.

24. The device according to claim 15, wherein the housing frame (4) is integrally connected to the sensor housing (3), and the end portion of the housing frame (4) directed to the second housing (2) is immersed into an elastic or plastic sealing material (8) that is preferably embedded into a groove-shaped projection of the second housing (2).
